(19) United States
(12) Patent Application Publication
(10) Pub. No.: US 2026/0281834 A1
(43) Pub. Date: Sep. 17, 2026

(54) LOAD BALANCING FOR UPLINK CARRIER AGGREGATION

(71) Applicant: T-MOBILE INNOVATIONS LLC, Overland Park, KS (US)

(72) Inventor: Mochamad MIRZA, Bothell, WA (US)

(21) Appl. No.: 19/081,533

(22) Filed: Mar. 17, 2025

(51) Int. Cl. H04W 36/00; H04L 5/00; H04L 27/26

(52) U.S. Cl. CPC H04W 36/00692; H04L 5/0098; H04L 27/2656

(57) ABSTRACT

The present disclosure relates to systems and methods for load balancing for uplink carrier aggregation. First user device(s) may be assigned to a first primary cell corresponding to a first uplink carrier aggregation (ULCA) group. The first primary cell comprises a first component carrier designated as the primary component carrier for the first ULCA group, and the first ULCA group further includes first secondary component carrier(s). Second user device(s) may be assigned to a second primary cell corresponding to a second ULCA group. The second primary cell comprises a second component carrier designated as the primary component carrier for the second ULCA group, and the second ULCA group further includes second secondary component carrier(s). The assignment of the second user device(s) may be based at least in part on an uplink load for the first ULCA group.

### SUMMARY

The present disclosure is directed, in part, to load balancing for uplink carrier aggregation substantially as shown in and/or described in connection with at least one of the figures, and as set forth more completely in the claims.

A high-level overview of various aspects of the present technology is provided in this section to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In aspects set forth herein, and at a high level, the technology described herein relates to load balancing by assigning user devices to different primary cells in one or more frequency bands (e.g., FR2 frequency bands) corresponding to different uplink carrier aggregation groups. User devices utilizing uplink carrier aggregation in FR2 frequency bands are typically assigned to the same primary cell and limited to utilizing four contiguous component carriers due to hardware limitations, power constraints, and standards. Aspects herein provide for assigning user devices to multiple primary cells that each correspond to different uplink carrier aggregation groups having non-overlapping component carriers. The user devices may be assigned to a particular primary cell based on uplink load, and the primary cell with less uplink load may be indicated as having a higher priority to user device at the initiation of a connection to the network. The techniques described herein provide better load balancing for uplink carrier aggregation and may significantly increase the uplink capacity when using carrier aggregation by utilizing previously unused component carriers.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example computing environment, in accordance with aspects herein.

FIG. 2 is a diagram illustrating an example network environment for use in accordance with aspects herein;

FIG. 3 is a diagram illustrating an example network environment for use in accordance with aspects herein;

FIG. 4 is flow chart illustrating an example method for use with aspects of the disclosure described herein; and

FIG. 5 is flow chart illustrating an example method for use with aspects of the disclosure described herein.

### DETAILED DESCRIPTION

The subject matter of embodiments of the present disclosure is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

By way of background, Carrier Aggregation (CA) is a provision of 5G and LTE standards that enables wireless operators to combine distinct carrier channels from a primary cell (PCell) and at least one secondary cell (SCell) into a single data channel to obtain higher data rates with user devices. The use of carrier aggregation improves data rates for user devices by increasing the overall bandwidth of the logical channel available to the user devices to send and/or receive data to the network operator core. In general, for a user device to benefit from carrier aggregation, the user device is located within an overlapped area of cell boundaries that includes coverage from a primary cell operating via a primary component carrier (e.g., at a first carrier frequency) and secondary cell(s) operating via secondary component carrier(s) (e.g., at second carrier frequencies). The primary component carrier and the secondary component carrier(s) can either be within the same frequency band or within different frequency bands. For carrier aggregation in FR2 frequency bands, the primary component carrier and the secondary component carrier(s) may both implement the same duplexing scheme (e.g., both implement time division duplexing (TDD)) to prevent inter-carrier interference.

Conventionally, a user device may typically be assigned to carrier aggregation groups based on the capabilities and/or location of the user device. For downlink carrier aggregation in FR2 frequency bands, a downlink carrier aggregation group may include up to eight component carriers, but uplink carrier aggregation group in FR2 frequency bands is typically limited to up to four component carriers. User devices typically only include up to four transmitters, and while it is technically feasible to add more transmitters to user devices (and thus enable larger groups of component carriers in the uplink), doing so may significantly increase the cost. User devices are also typically assigned to the same primary cell, so only four component carriers out of the total number of component carriers (e.g., eight or higher) are utilized for uplink carrier aggregation. Therefore, a significant amount of available capacity is unutilized for uplink carrier aggregation when using conventional techniques.

Unlike conventional solutions, the present disclosure includes establishing multiple primary cells and assigning user devices to particular primary cells in a manner that provides better load balancing amongst component carriers used for carrier aggregation. User devices utilizing uplink carrier aggregation (e.g., in FR2 frequency bands) may be assigned to one of the multiple primary cells, which correspond to different uplink carrier aggregation groups having non-overlapping component carriers. The user devices may be assigned to a particular primary cell based at least in part on uplink load. For example, the primary cell with less uplink load may be indicated as having a higher priority to user device at the initiation of a connection to the network such that the user device will utilize that primary cell for a connection and its corresponding uplink carrier aggregation group. The techniques described herein may significantly increase the uplink capacity for the network and capacity utilization in general when using carrier aggregation by assigning user devices to uplink carrier aggregation groups that include previously unused component carriers (e.g., that are in FR2 frequency bands and use a TDD frame configuration).

In one aspect, a system is provided. The system includes one or more access nodes configured to wirelessly communicate with a plurality of user devices. The system further includes one or more processors and one or more non-transitory, computer-readable media storing computer-usable instructions that, when executed by the one or more processors, cause the one or more processors to perform a method. The method includes assigning a first user device to a first primary cell corresponding to a first uplink carrier aggregation group. The first primary cell comprises a first component carrier designated as the primary component carrier for the first uplink carrier aggregation group, and the first uplink carrier aggregation group further includes one or more first secondary component carriers. The method further includes assigning a second user device to a second primary cell corresponding to a second uplink carrier aggregation group. The second primary cell comprises a second component carrier designated as the primary component carrier for the second uplink carrier aggregation group, and the second uplink carrier aggregation group further includes one or more second secondary component carriers.

In another aspect, an apparatus is provided. The apparatus includes one or more processors and one or more non-transitory, computer-readable media storing computer-usable instructions that, when executed by the one or more processors, cause the one or more processors to perform a method. The method includes assigning first user devices to a first primary cell corresponding to a first uplink carrier aggregation group. The first primary cell comprises a first component carrier designated as the primary component carrier for the first uplink carrier aggregation group, and the first uplink carrier aggregation group further includes one or more first secondary component carriers. The method further includes determining whether an uplink load for the first uplink carrier aggregation group exceeds an uplink load threshold. The method further includes, in response to a determination that the uplink load for the first uplink carrier aggregation group exceeds the uplink load threshold, assigning one or more second user devices to a second primary cell corresponding to a second uplink carrier aggregation group. The second primary cell comprises a second component carrier designated as the primary component carrier for the second uplink carrier aggregation group, and the second uplink carrier aggregation group includes a one or more second secondary component carriers.

In yet another aspect, a method is provided. The method includes assigning one or more first user devices to a first primary cell corresponding to a first uplink carrier aggregation group. The first primary cell comprises a first component carrier designated as the primary component carrier for the first uplink carrier aggregation group, and the first uplink carrier aggregation group further includes one or more first secondary component carriers. The method further includes assigning, based at least in part on an uplink load for the first uplink carrier aggregation group, one or more second user devices to a second primary cell corresponding to a second uplink carrier aggregation group. The second primary cell comprises a second component carrier designated as the primary component carrier for the second uplink carrier aggregation group, and the second uplink carrier aggregation group further includes one or more second secondary component carriers.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

As used herein, the term “base station” (used for providing user devices with access to the telecommunication services) or “access node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

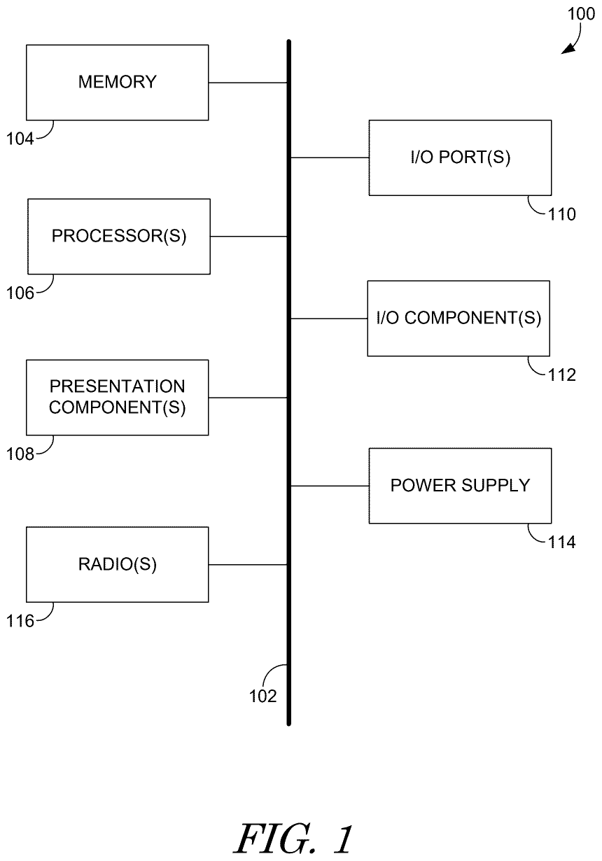

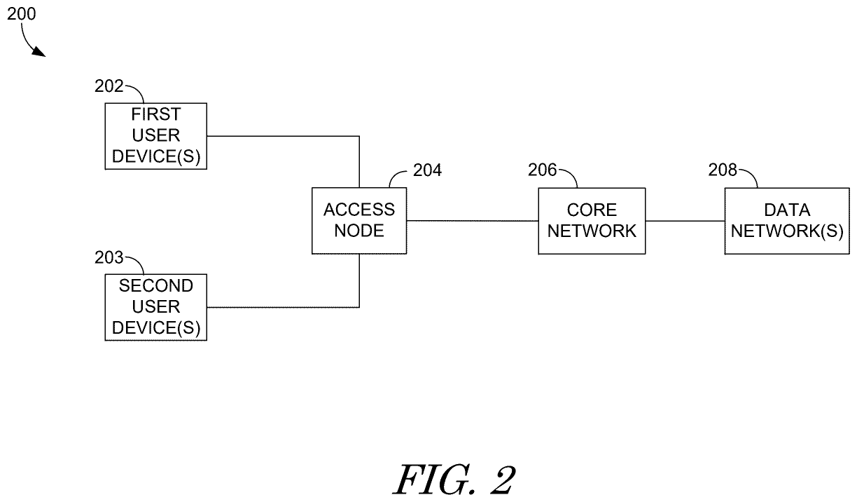

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to the first user device(s) 202 and second user device(s) 203 described herein with respect to FIG. 2. A user device may also be, in another embodiment, similar to the computing device 100, described herein with respect to FIG. 1.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 1, a diagram is depicted of an exemplary computing environment suitable for use in implementations of the present disclosure. In particular, the exemplary computer environment is shown and designated generally as computing device 100. Computing device 100 is but one example of a suitable computing environment and is not intended to suggest any limitation as to the scope of use or functionality of the embodiments described herein. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, the computing device 100 includes bus 102 that directly or indirectly couples one or more of the following devices: memory 104, one or more processors 106, one or more presentation components 108, one or more input/output (I/O) ports 110, one or more I/O components 112, power supply 114, and radio 116. Bus 102 represents what may be one or more busses (such as an address bus, data bus, or combination thereof). The components of FIG. 1 are shown with lines for the sake of clarity. However, it should be understood that the functions performed by one or more components of the computing device 100 may be combined or distributed amongst the various components. For example, a presentation component such as a display device may be one of I/O component(s) 112. In some embodiments, a base station, RAN, and/or other access node, implementing one or more aspects of the present disclosure may comprise a computing device 100. In some embodiments, the first user device(s) 202 from FIG. 2 may comprise a computing device such as the computing device 100.

The processors of the computing device 100, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

The computing device 100 typically includes a variety of computer-readable media. Computer-readable media can be any available non-transient media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable non-transient media implemented in any method or technology for storage of information such as computer-readable instructions, data structures, program modules or other data. Computer storage media includes non-transient RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media and computer-readable media do not comprise a propagated data signal or signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 104 includes tangible, non-transient, computer-storage media in the form of volatile and/or nonvolatile memory. The memory 104 may be removable, non-removable, or a combination thereof. Exemplary memory includes solid-state memory, hard drives, optical-disc drives, etc. Computing device 100 includes one or more processors 106 that read data from various entities such as bus 102, memory 104 or I/O component(s) 112. One or more presentation components 108 may present data indications to a person or other device. Exemplary one or more presentation components 108 include a display device, speaker, printing component, vibrating component, etc. I/O port(s) 110 allow computing device 100 to be logically coupled to other devices including I/O component(s) 112, some of which may be built in computing device 100. Illustrative I/O component(s) 112 include a microphone, joystick, game pad, satellite dish, scanner, printer, wireless device, etc.

The radio(s) 116 represent a radio that facilitates communication with a wireless telecommunications network. For example, radio(s) 116 may be used to establish communications with a user device and/or a RAN. Illustrative wireless telecommunications technologies include CDMA, GPRS, TDMA, GSM, 802.11, and the like. The radio(s) 116 may carry wireless communication functions or operations using any number of desirable wireless communication protocols, including 802.11 (Wi-Fi), WiMAX, LTE, 3G, 4G, LTE, 5G, NR, VoLTE, VoNR, or other VoIP communications. In some embodiments, the radio(s) 116 may support multi-modal connections that include a combination of 3GPP radio technologies (e.g., 4G, 5G and/or 6G) and/or non-3GPP radio technologies. In aspects, the radio(s) 116 may be configured to communicate using the same protocol but in other aspects they may be configured to communicate using different protocols. In some embodiments, including those that the radio(s) 116 or wireless links are configured for communicating using the same protocol, the radio(s) 116 may be configured to communicate on distinct frequencies or frequency bands (e.g., as part of a carrier aggregation scheme). As can be appreciated, in various embodiments, the radio(s) 116 can be configured to support multiple technologies and/or multiple frequencies; for example, at least one of the radio(s) 116 may be configured to communicate with a base station according to a cellular communication protocol (e.g., 4G, 5G, 6G, or the like), and at least one of the radio(s) 116 may be configured to communicate with one or more other computing devices according to a local area communication protocol (e.g., IEEE 802.11 series, Bluetooth, NFC, z-wave, or the like).

Turning now to FIG. 2, FIG. 2 is a diagram illustrating an example network environment 200 in which implementations of the present disclosure may be employed. Such a network environment is illustrated and designated generally as network environment 200. Network environment 200 is but one example of a suitable network environment and is not intended to suggest any limitation as to the scope of use or functionality of the disclosure. Neither should the network environment 200 be interpreted as having any dependency or requirement relating to any one or combination of components illustrated.

As shown in FIG. 2, network environment 200 comprises one or more first user devices 202, one or more second user devices 203, an access node 204, a core network 206, and one or more data networks 208. The first user device(s) 202 and the second user device(s) 203 may include any device employed by an end-user to communication with a telecommunications network, such as a wireless telecommunications network. The first user device(s) 202 and the second user device(s) 203 may, in general, comprise forms of equipment and machines such as but, not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, the first user device(s) 202 and the second user device(s) 203 may include computing devices such as, but not limited to, handheld personal computing devices, cellular phones, smartphones, tablets, laptops, and similar consumer equipment, or stationary desktop computing devices, workstations, servers and/or network infrastructure equipment. As such, the first user device(s) 202 and the second user device(s) 203 may be a mobile user device or a stationary user device. The first user device(s) 202 and the second user device(s) 203 may include one or more processors, and one or more non-transient computer-readable media for executing code to carry out the functions of the first user device(s) 202 and the second user device(s) 203 described herein. The computer-readable media may include computer-readable instructions executable by the one or more processors. In some embodiments, the first user device(s) 202 and the second user device(s) 203 may be implemented using a computing device 100 as discussed below with respect to FIG. 1.

The access node 204 may comprise a base station, Wi-Fi access point, or other type of access node. In the embodiment shown in FIG. 2, the access node 204 may function as an access node via which the first user device(s) 202 and the second user device(s) 203 within coverage area of the access node 204 can wirelessly access services of the core network 206, such as telecommunications and data connectivity. In the context of fourth generation (4G) Long Term Evolution (LTE), the access node 204 may be referred to as an eNodeB, or eNB. In the context of fifth generation (5G) New Radio (NR), the access node 204 may be referred to as a gNodeB, or gNB. Nodes may be terrestrial or extraterrestrial. Other terminology may also be used depending on the specific implementation technology. In some embodiments, the access node 204 may comprise a multi-modal network (for example comprising one or more multi-modal access devices) where multiple radios supporting different systems are integrated into the radio of the access node 204. Such a multi-modal RAN may support a combination of 3GPP radio technologies (e.g., 4G, 5G and/or 6G) and/or non- 3GPP radio technologies.

As shown in FIG. 2, the network environment 200 comprises a core network 206 and data network(s) 208. The core network 206 may be a component of a wireless communications network that provides one or more wireless network services to one or more devices (e.g., user device(s) 202 and user device(s) 203) within the coverage areas of a plurality of nodes, including the access node 204. In particular, core network 206 provides combinations of network services to the first user device(s) 202 for one or more public land mobile networks (PLMNs) that the first user device(s) 202 and the second user device(s) 203 may attach to via channels of one or more RF bands (referred to herein as RF band layers). The core network 206 may be configured to support standalone 5G operation.

The network environment 200 is generally configured for wirelessly connecting the first user device(s) 202 and the second user device(s) 203 to other devices via access node 204, via other RAN and/or other local wireless cellular access points, and/or via other telecommunication networks or a publicly-switched telecommunication network (PSTN), for example. The network environment 200 may be generally configured, in some embodiments, for wirelessly connecting the first user device(s) 202 and the second user device(s) 203 to data or services that may be accessible on one or more application servers or other functions, nodes, or servers (such as services provided by servers of the data network(s) 208, for example). The data network(s) 208, in aspects, may include private data networks or a public data networks (e.g., the Internet).

The access node 204 may utilize multiple primary cells and multiple secondary cells for uplink carrier aggregation for the first user device(s) 202 and the second user device(s) 203. A primary cell may comprise the cell that the first user device(s) 202 and/or the second user device(s) 203 initially finds, connects to, and uses for control signaling in addition to data plane traffic. A secondary cell may be an additional cell that may be configured (activated) for enhancing data throughput in conjunction with the primary cell (e.g., for carrier aggregation).

The access node 204 may utilize a first primary cell comprising a first component carrier that is designated as the primary component carrier for a first uplink carrier aggregation group. The access node 204 may further utilize one or more first secondary cells comprising respective secondary component carriers for first uplink carrier aggregation group. The access node 204 may utilize a second primary cell comprising a second component carrier that is designated as the primary component carrier for a second uplink carrier aggregation group. The access node 204 may further utilize one or more second secondary cells comprising respective secondary component carriers for first uplink carrier aggregation group. The component carriers included in the first uplink carrier aggregation group are district from the component carriers included in the second uplink carrier aggregation group. That is, the first uplink carrier aggregation group and the second uplink carrier aggregation group do not share any component carriers.

The component carriers from the first uplink carrier aggregation group may be implemented using intra-band, contiguous carrier aggregation where the first component carrier and first secondary component carrier(s) are contiguous component carriers in a single frequency band. In some embodiments, the component carriers from the first uplink carrier aggregation group may be implemented using intra-band, non-contiguous carrier aggregation where the first component carrier and first secondary component carrier(s) are non-contiguous component carriers in a single frequency band. In other embodiments, the component carriers from the first uplink carrier aggregation group may be implemented using inter-band carrier aggregation where the first component carrier is in a first frequency band and at least one of the first secondary component carrier(s) is in a second frequency band different than the first frequency band. The component carriers from the second uplink carrier aggregation group may be implemented using intra-band, contiguous carrier aggregation; intra-band, non-contiguous carrier aggregation; or inter-band carrier aggregation in a similar manner.

The component carriers from the first uplink carrier aggregation group and the second uplink carrier aggregation group may utilize a common Time Division Duplex (TDD) frame structure, which may help prevent inter-carrier interference. For example, the first component carrier, the second component carrier, the first secondary component carrier(s), and the second secondary component carrier(s) may all use the same TDD frame structure. Further, in some embodiments, the first uplink carrier aggregation group and the second uplink carrier aggregation group both operate in one or more FR2 frequency bands. For example, the first component carrier, the second component carrier, the first secondary component carrier(s), and the second secondary component carrier(s) may all operate in one or more FR2 frequency bands. While some embodiments described herein primarily refer to FR2 frequency bands, it should be understood that the disclosure is not limited to FR2 frequency bands, and similar techniques may be implemented using other frequency bands including, but not limited to, other cellular frequency bands (e.g., LTE frequency bands, FR1 frequency bands, etc.) or Wi-Fi frequency bands (e.g., 2.4 GHz, 5 GHz, 6 GHz, mmWave, etc.).

The first component carrier for the first primary cell and the second component carrier for the second primary cell may be selected to maximize the utilization of capacity for the available component carriers. For example, if eight component carriers are able to be utilized by the access node 204 and the first and second uplink carrier aggregation groups are both implemented using intra-band contiguous carrier aggregation, then the first component carrier of the first primary cell and the second component carrier of the second primary cell may be selected to be as far apart from each other as possible. Where the first and second uplink carrier aggregation groups are both implemented using intra-band, non-contiguous carrier aggregation or inter-band carrier aggregation, there may be more flexibility is selected the first component carrier and the second component carrier because there is no requirement that the secondary component carrier(s) be contiguous.

In some embodiments, the first user device(s) 202 may be assigned to the first uplink carrier aggregation group and the second user device(s) 203 may be assigned to the second carrier aggregation group in an alternating manner. For example, one user device initiating a connection to the access node 204 may be assigned to the first uplink carrier aggregation group (e.g., referred to as the first user device(s) 202) and the next user device initiating a connection to the access node 204 may be assigned to the second uplink carrier aggregation group (e.g., referred to as the second user device(s) 203). It should be understood that other types of repeating patterns (e.g., every two user devices assigned to a particular uplink carrier aggregation group) may be used and the frequency of the repetition may vary over time and be configurable by the network.

In some embodiments, the user devices may be assigned to the first uplink carrier aggregation group or the second uplink carrier aggregation group based on uplink load. The uplink load for a particular uplink carrier aggregation group may be determined based on slot utilization, physical resource block (PRB) utilization, number of users, and/or other metrics indicative of uplink load. The user devices may be assigned to the uplink carrier aggregation group with the lowest uplink load when the user devices are initiating a connection to the access node 204. Alternatively, the user devices may be assigned to the first uplink carrier aggregation group until the uplink load for the first uplink carrier aggregation group exceeds an uplink load threshold (e.g., 50%). The uplink load threshold may be configurable by the network and vary over time depending on network conditions. In response to the uplink load for the first uplink carrier aggregation group exceeding the uplink load threshold, user devices may be assigned to the second uplink carrier aggregation group.

Depending on the number of component carriers available to be utilized by the access node 204, additional uplink carrier aggregation groups may be defined (e.g., additional primary cells may be established and secondary cells activated) and utilized for uplink carrier aggregation in a manner similar to that described herein with respect to the first and second uplink carrier aggregation groups. For example, if twelve component carriers are available to be utilized by the access node 204, then a third primary cell may be established along with third secondary cell(s) and each uplink carrier aggregation group may utilize four component carriers.

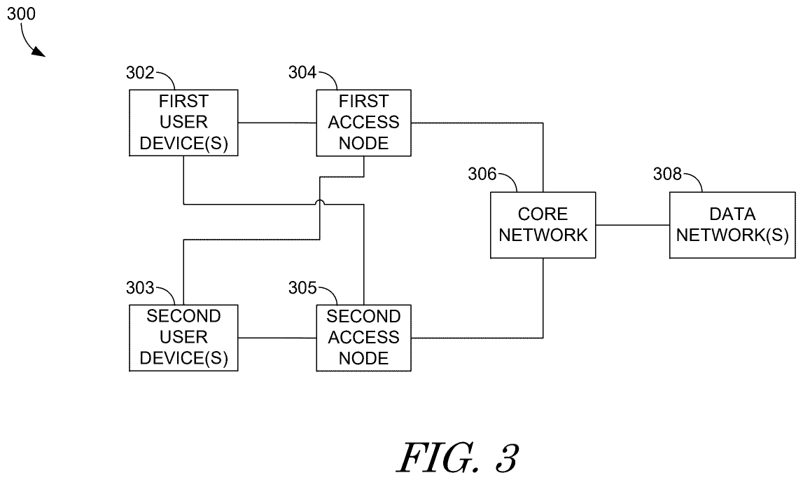

Turning now to FIG. 3, FIG. 3 is a diagram illustrating an example network environment 300 in which implementations of the present disclosure may be employed. Such a network environment is illustrated and designated generally as network environment 300. Network environment 300 is but one example of a suitable network environment and is not intended to suggest any limitation as to the scope of use or functionality of the disclosure. Neither should the network environment 300 be interpreted as having any dependency or requirement relating to any one or combination of components illustrated.

As shown in FIG. 3, network environment 300 comprises similar components as those included in network environment 200 described above with respect to FIG. 2, and the components have been numbered similarly starting with “3” in FIG. 3 instead of starting with “2” as in FIG. 2. Only the differences between the network environment 300 and the network environment 200 will be discussed specifically with respect to FIG. 3.

The network environment 300 comprises a first access node 304 and a second access node 305. The first access node 304 and the second access node 305 may comprise base stations, Wi-Fi access points, or other types of access nodes. In the embodiment shown in FIG. 3, the first access node 304 and the second access node 305 may function as an access node via which the first user device(s) 302 and the second user device(s) 303 within coverage area of the first access node 304 and the second access node 305 can wirelessly access services of the core network 206, such as telecommunications and data connectivity. In the context of fourth generation (4G) Long Term Evolution (LTE), the first access node 304 and the second access node 305 may be referred to as an eNodeB, or eNB. In the context of fifth generation (5G) New Radio (NR), the first access node 304 and the second access node 305 may be referred to as a gNodeB, or gNB. Nodes may be terrestrial or extraterrestrial. Other terminology may also be used depending on the specific implementation technology. In some embodiments, the access node 204 may comprise a multi-modal network (for example comprising one or more multi-modal access devices) where multiple radios supporting different systems are integrated into the radio of the access node 204. Such a multi-modal RAN may support a combination of 3GPP radio technologies (e.g., 4G, 5G and/or 6G) and/or non-3GPP radio technologies.

The network environment 300 is generally configured for wirelessly connecting the first user device(s) 302 and the second user device(s) 303 to other devices via the first access node 304 and the second access node 305, via other RAN and/or other local wireless cellular access points, and/or via other telecommunication networks or a publicly-switched telecommunication network (PSTN), for example. The network environment 300 may be generally configured, in some embodiments, for wirelessly connecting the first user device(s) 302 and the second user device(s) 303 to data or services that may be accessible on one or more application servers or other functions, nodes, or servers (such as services provided by servers of the data network(s) 308, for example).

In some embodiments, the first user device(s) 302 and/or the second user device(s) 303 may be simultaneously connected to the first access node 304 and the second access node 305 (e.g., using various types of dual connectivity). The first access node 304 may operate as the master node and the second access node 305 may operate as the secondary node. The first access node 304 may establish one or more primary cells (referred to as PCell(s)) and the second access node 305 may establish one or more primary cells (referred to as PSCell(s)). Both the first access node 304 and the second access node 305 may also activate secondary cells for use in carrier aggregation.

In some embodiments, the first uplink carrier aggregation group and/or the second uplink carrier aggregation group may include component carriers from both the first access node 304 and the second access node 305. For example, the first uplink carrier aggregation group or the second uplink carrier aggregation group may comprise a first component carrier from the first access node 304 that is designated as the primary component carrier and at least one secondary component carrier from the second access node 305. Similarly, the first uplink carrier aggregation group or the second uplink carrier aggregation group may comprise a first component carrier from the second access node 305 that is designated as the primary component carrier and at least one secondary component carrier from the first access node 304. Thus, the first user device(s) 302 and the second user device(s) 303 may utilize one or more cells of the first access node 304 and one or more cells of the second access node 305 for uplink carrier aggregation. The composition of the uplink carrier aggregation groups and the assignment of the user devices to the uplink carrier aggregation groups may otherwise be similar to that described above with respect to FIG. 2.

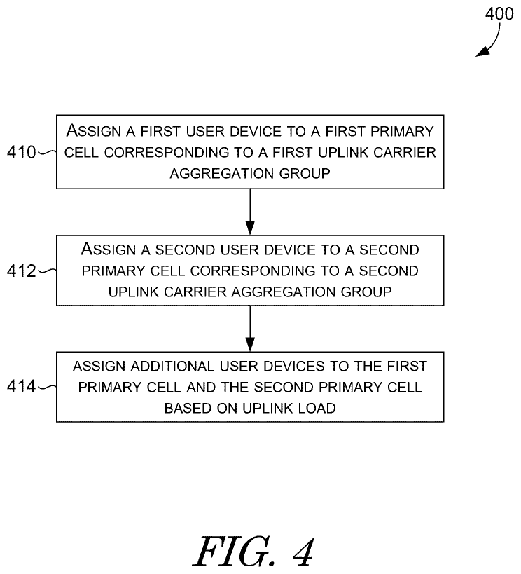

Referring to FIG. 4, a flow chart representing an example method 400 is provided, in accordance with some embodiments of the present disclosure. It should be understood that the features and elements described herein with respect to the method 400 of FIG. 4 may be used in conjunction with, in combination with, or substituted for elements of, any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa.

At block 410, the method 400 includes assigning a first user device to a first primary cell corresponding to a first uplink carrier aggregation group. The first primary cell may comprise a first component carrier designated as the primary component carrier for the first uplink carrier aggregation group, and the first uplink carrier aggregation group may further include first secondary component carrier(s). The first uplink carrier aggregation group may include intra-band contiguous component carriers (e.g., first component carrier and the first secondary component carrier(s) are contiguous and within a single frequency band), intra-band, non-contiguous component carriers (e.g., first component carrier and the first secondary component carrier(s) are non-contiguous and within a single frequency band), or inter-band component carriers (e.g., first component carrier is within a first frequency band and at least one of the first secondary component carrier(s) is within a different frequency band).

At block 412, the method 400 includes assigning a second user device to a second primary cell corresponding to a second uplink carrier aggregation group. The second primary cell may comprise a second component carrier designated as the primary component carrier for the second uplink carrier aggregation group, and the second uplink carrier aggregation group may further include second secondary component carrier(s). The second uplink carrier aggregation group may include intra-band contiguous component carriers (e.g., second component carrier and the second secondary component carrier(s) are contiguous and within a single frequency band), intra-band, non-contiguous component carriers (e.g., second component carrier and the second secondary component carrier(s) are non-contiguous and within a single frequency band), or inter-band component carriers (e.g., second component carrier is within a second frequency band and at least one of the second secondary component carrier(s) is within a different frequency band).

At block 414, the method 400 includes assigning additional user devices to the first primary cell and the second primary cell based on uplink load. In some embodiments, the additional user devices may be assigned to the first primary cell or the second primary cell based on an alternating pattern (e.g., every other) or a different type of pattern that repeats over time. The additional user devices may also be assigned to the uplink carrier aggregation group having the lowest uplink load.

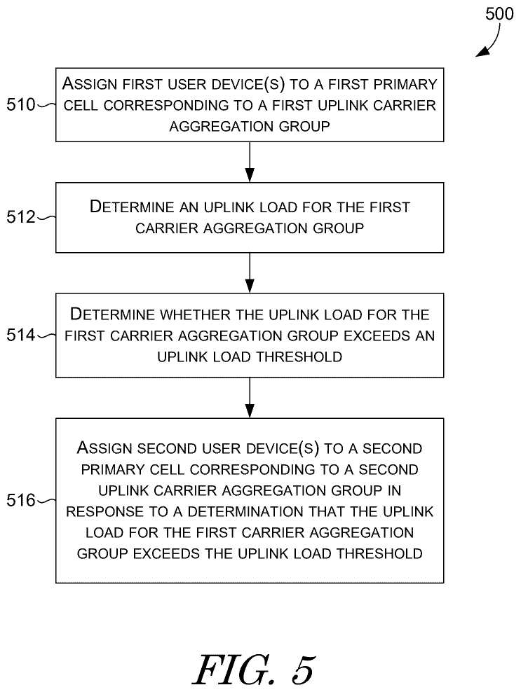

Referring to FIG. 5, a flow chart representing an example method 500 is provided, in accordance with some embodiments of the present disclosure. It should be understood that the features and elements described herein with respect to the method 500 of FIG. 5 may be used in conjunction with, in combination with, or substituted for elements of, any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

At block 510, the method 500 includes assigning first user device(s) to a first primary cell corresponding to a first uplink carrier aggregation group. The first primary cell may comprise a first component carrier designated as the primary component carrier for the first uplink carrier aggregation group, and the first uplink carrier aggregation group may further include first secondary component carrier(s).

At block 512, the method 500 includes determining an uplink load for the first uplink carrier aggregation group. In some embodiments, the uplink load for the first uplink carrier aggregation group may be determined based on slot utilization, PRB utilization, number of users, and/or other metrics indicative of uplink load.

At block 514, the method 500 includes determining whether the uplink load for the first uplink carrier aggregation group exceeds an uplink load threshold. In some embodiments, the uplink load threshold may be configurable by the network. The uplink load threshold may vary over time and be configured based on network conditions, performance requirements, or other factors.

At block 516, the method 500 includes assigning second user device(s) to a second primary cell corresponding to a second uplink carrier aggregation group in response to a determination that the uplink load for the first uplink carrier aggregation group exceeds an uplink load threshold. The second primary cell may comprise a second component carrier designated as the primary component carrier for the second uplink carrier aggregation group, and the second uplink carrier aggregation group may further include second secondary component carrier(s). In some embodiments, user device(s) initiating a connection to the network may be assigned to the second primary cell corresponding to a second uplink carrier aggregation group until the uplink load of the second uplink carrier aggregation group is similar to the uplink load for the first uplink carrier aggregation group. If additional primary cells corresponding to additional uplink carrier aggregation groups are defined, then user device(s) initiating a connection to the network may be assigned to those additional primary cells in a manner similar to that described herein.

As used herein, the terms “function”, “unit”, “server”, “node” and “module” are used to describe computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system, comprising:
one or more access nodes configured to wirelessly communicate with a plurality of user devices;
one or more processors; and
one or more non-transitory, computer-readable media storing computer-usable instructions that, when executed by the one or more processors, cause the one or more processors to:
assign a first user device to a first primary cell corresponding to a first uplink carrier aggregation group, wherein the first primary cell comprises a first component carrier designated as a primary component carrier for the first uplink carrier aggregation group, wherein the first uplink carrier aggregation group further includes one or more first secondary component carriers; and
assign a second user device to a second primary cell corresponding to a second uplink carrier aggregation group, wherein the second primary cell comprises a second component carrier designated as a primary component carrier for the second uplink carrier aggregation group, wherein the second uplink carrier aggregation group further includes one or more second secondary component carriers.

2. The system of claim 1, wherein the first component carrier and the one or more first secondary component carriers comprise contiguous component carriers in a first frequency band.

3. The system of claim 1, wherein the first component carrier and the one or more first secondary component carriers comprise non-contiguous component carriers in a first frequency band.

4. The system of claim 1, wherein the first component carrier is in a first frequency band, wherein at least one of the one or more first secondary component carriers is in a second frequency band different than the first frequency band.

5. The system of claim 1, wherein the one or more access nodes comprise a first access node and a second access node, wherein the first primary cell is serviced by the first access node, wherein the second primary cell is serviced by the second access node.

6. The system of claim 1, wherein the one or more access nodes comprise a first access node, wherein the first primary cell and the second primary cell are serviced by the first access node.

7. The system of claim 1, wherein the computer-usable instructions, when executed by the one or more processors, further cause the one or more processors to assign additional user devices to the first primary cell and the second primary cell based on uplink load.

8. The system of claim 1, wherein the computer-usable instructions, when executed by the one or more processors, further cause the one or more processors to:
determine an uplink load for the first uplink carrier aggregation group;
determine whether the uplink load for the first uplink carrier aggregation group exceeds an uplink load threshold; and
assign the second user device to the second primary cell corresponding to the second uplink carrier aggregation group in response to a determination that the uplink load for the first uplink carrier aggregation group exceeds the uplink load threshold.

9. The system of claim 1, wherein the first component carrier and the one or more first secondary component carriers are within one or more Frequency Range 2 (FR2) frequency bands.

10. The system of claim 1, wherein the first component carrier, the second component carrier, the one or more first secondary component carriers, and the one or more second secondary component carriers utilize a common Time Division Duplex frame structure.

11. An apparatus, comprising:
one or more processors; and
one or more non-transitory, computer-readable media storing computer-usable instructions that, when executed by the one or more processors, cause the one or more processors to:
assign first user devices to a first primary cell corresponding to a first uplink carrier aggregation group, wherein the first primary cell comprises a first component carrier designated as a primary component carrier for the first uplink carrier aggregation group, wherein the first uplink carrier aggregation group further includes one or more first secondary component carriers;
determine whether an uplink load for the first uplink carrier aggregation group exceeds an uplink load threshold; and
in response to a determination that the uplink load for the first uplink carrier aggregation group exceeds the uplink load threshold, assign one or more second user devices to a second primary cell corresponding to a second uplink carrier aggregation group, wherein the second primary cell comprises a second component carrier designated as a primary component carrier for the second uplink carrier aggregation group, wherein the second uplink carrier aggregation group includes a one or more second secondary component carriers.

12. The apparatus of claim 11, wherein the uplink load for the first uplink carrier aggregation group is determined based on a slot utilization, a physical resource block utilization, and/or a number of users for the first uplink carrier aggregation group.

13. The apparatus of claim 11, wherein the first component carrier and the one or more first secondary component carriers comprise contiguous component carriers in a first frequency band.

14. The apparatus of claim 11, wherein the first component carrier and the one or more first secondary component carriers comprise non-contiguous component carriers in a first frequency band.

15. The apparatus of claim 11, wherein the first component carrier is in a first frequency band, wherein at least one of the one or more first secondary component carriers is in a second frequency band different than the first frequency band.

16. The apparatus of claim 11, wherein the first component carrier, the second component carrier, the one or more first secondary component carriers, and the one or more second secondary component carriers utilize a common Time Division Duplex frame structure.

17. The apparatus of claim 11, wherein the first component carrier and the one or more first secondary component carriers are within one or more Frequency Range 2 (FR2) frequency bands.

18. A method, comprising:
assigning one or more first user devices to a first primary cell corresponding to a first uplink carrier aggregation group, wherein the first primary cell comprises a first component carrier designated as a primary component carrier for the first uplink carrier aggregation group, wherein the first uplink carrier aggregation group further includes one or more first secondary component carriers; and
assigning, based at least in part on an uplink load for the first uplink carrier aggregation group, one or more second user devices to a second primary cell corresponding to a second uplink carrier aggregation group, wherein the second primary cell comprises a second component carrier designated as a primary component carrier for the second uplink carrier aggregation group, wherein the second uplink carrier aggregation group further includes one or more second secondary component carriers.

19. The method of claim 18, the method further comprising:
determining whether the uplink load for the first uplink carrier aggregation group exceeds an uplink load threshold; and
assigning the one or more second user devices to the second primary cell corresponding to the second uplink carrier aggregation group in response to a determination that the uplink load for the first uplink carrier aggregation group exceeds the uplink load threshold.

20. The method of claim 18, further comprising assigning one or more third user devices to the first primary cell or the second primary cell based at least in part on an uplink load for the second uplink carrier aggregation group.
